(19) United States
(12) Patent Application Publication
(10) Pub. No.: US 2014/0323636 A1
(43) Pub. Date: Oct. 30, 2014

(54) SYNTHETIC MARBLE WITH HIGH HARDNESS AND METHOD OF MANUFACTURING THE SAME

(71) Applicant: LG HAUSYS, LTD., Seoul (KR)

(72) Inventor: Sangho Shin, Cheongwon-gun (KR)

(73) Assignee: LG HAUSYS, LTD., Seoul (KR)

(21) Appl. No.: 14/363,569

(22) PCT Filed: Dec. 12, 2012
(86) PCT No.: PCT/KR2012/010812

§ 371 Date: Jun. 6, 2014

(30) Foreign Application Priority Data
Dec. 13, 2011 (KR) 10-2011-0133346

(51) Int. Cl. C04B 14/04

(52) U.S. Cl. CPC C04B 14/04
USPC 524/493; 524/558; 264/134

(57) ABSTRACT

Disclosed therein is a synthetic marble with high hardness and a method of manufacturing the synthetic marble, in which the raw material for the surface of a manufactured synthetic marble is silica because a step of coating a material of a high hardness, silica, on a sheet is included in the process of manufacturing the synthetic marble, so that the synthetic marble is not contaminated because it is not scratched due to the solid surface of high hardness, and is easy to clean.

### TECHNICAL FIELD

The present invention relates to a synthetic marble with high hardness and a method of manufacturing the same, and more particularly, to a synthetic marble with high hardness and a method of manufacturing the synthetic marble, in which the raw material for the surface of a manufactured synthetic marble is silica because a step of coating a material of a high hardness, silica, on a sheet is included in the process of manufacturing the synthetic marble, so that the synthetic marble is not contaminated because it is not scratched due to the solid surface of high hardness, and is easy to clean.

### BACKGROUND ART

In general, synthetic marble manufactured of acryl-based resin has been widely used as a material for counter tables and various kinds of interior decoration because it provides a beautiful appearance and excellent processability and is more lightweight than natural marble and has high strength. However, the synthetic marble has a problem in that it is easily contaminated due to a low surface hardness, and especially, it is difficult to clean due to contamination of scratched portions.

The acryl-based synthetic marble is generally manufactured through the steps of mixing filler, such as aluminum hydroxide, calcium carbonate, and silica, pigments, and a hardening agent to syrup which is made by mixing monomer, such as methyl-methacrylate, and polymethyl methacrylate, and casting and hardening the mixture in a mold and a continuous steel belt.

In this instance, pigments and chips are used in order to show shapes and colors. The main ingredient of the chip is generally the same as the synthetic marble. After the chips are manufactured in the same process as the synthetic marble by putting a pigment of a single color, they are pulverized to thereby have various colors and particle sizes.

In prior arts, because the synthetic marble is manufactured by a method of sanding the surface after being casted, it needs additional process of coating the surface of the synthetic marble in order to increase the surface hardness. Accordingly, the synthetic marble according to the prior arts has a problem in that manufacturing expenses are increased.

### DISCLOSURE OF INVENTION

### Technical Problem

Accordingly, the present invention has been made in an effort to solve the above-mentioned problems occurring in the prior arts, and it is an object of the present invention to provide a synthetic marble with scratch resistance and high hardness and a method of manufacturing the same.

The above and other objects, features and advantages of the present invention will be apparent from the following detailed description of the preferred embodiments of the invention in conjunction with the accompanying drawings.

### Solution to Problem

To achieve the above objects, the present invention provides a synthetic marble having a surface layer whose raw material is a compound with a pencil hardness of 7 to 9.

In another aspect, the present invention provides a method of manufacturing the synthetic marble comprising the steps of: (a) kneading the raw material of the synthetic marble; (b) making the kneaded material into a sheet; (c) putting and mulling sheets of at least two kinds in a kneader; (d) putting and mulling pearl pigments; (e) making the mulled material into a sheet; (f) coating a compound with a pencil hardness of 7 to 9 to the sheet; and (g) charging and casting the coated compound in a mold and removing the form and cooling the formed product.

### Advantageous Effects of Invention

As shown in FIG. 1, the synthetic marble according to the present invention is coated and casted with a material consisting of silica with high hardness, so that it has a pencil hardness of 7H to 8H so s to secure scratch resistance and hardness greater than the existing casted products with hardness of 5H.

### BRIEF DESCRIPTION OF DRAWINGS

FIG. 1 is a photograph of a synthetic marble panel according to a preferred embodiment of the present invention.

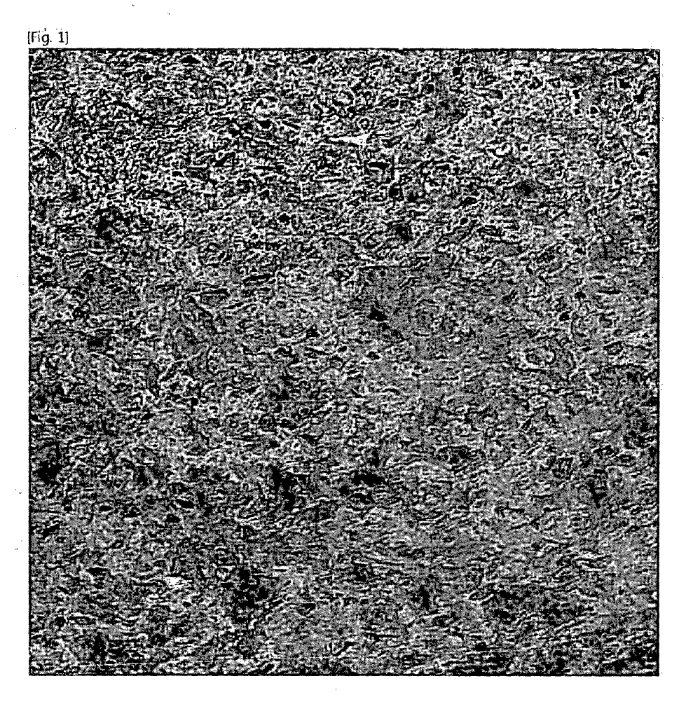

FIG. 2 is a flow chart of a manufacturing method of the synthetic marble according to the present invention.

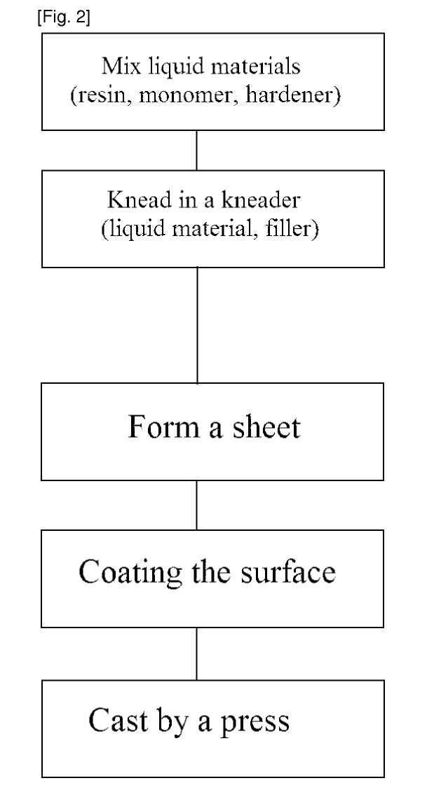

### BEST MODE FOR CARRYING OUT THE INVENTION

Reference will be now made in detail to the preferred embodiment of the present invention with reference to the attached drawings.

In a synthetic marble according to the present invention, a raw material of a surface layer is a compound with a pencil hardness of 7 to 9.

The compound with the pencil hardness of 7 to 9 is at least one selected from a group consisting of silica and silicon carbide, preferably, silica.

It is preferable that the content of the compound with the pencil hardness of 7 to 9 is 50 parts by weight to 300 parts by weight with respect to 100 parts by weight of resin.

It is also preferable that the particle size of silica is 1 μm to 30 μm.

Moreover, a method of manufacturing the synthetic marble according to the present invention includes the steps of: (a) kneading the raw material of the synthetic marble; (b) making the kneaded material into a sheet; (c) putting and mulling sheets of at least two kinds in a kneader; (d) putting and mulling pearl pigments; (e) making the mulled material into a sheet; (f) coating a compound with a pencil hardness of 7 to 9 to the sheet; and (g) charging and casting the coated compound in a mold and removing the form and cooling the formed product.

The method of manufacturing the synthetic marble according to the present invention will be described in more detail. The method of manufacturing the synthetic marble includes the steps of: (a) kneading the raw material of the synthetic marble; (b) making the kneaded material into a sheet; (c) putting sheets of at least two kinds in a kneader and mulling the sheets in order to form a marble pattern in the compound state; (d) putting and mulling pearl pigments; (e) making the mulled material into a sheet; (f) thinly coating a compound with a pencil hardness of 7 to 9 to the sheet; (g) charging the coated compound in a mold; (h) casting the compound with a press; (i) removing the form of the casted product; (j) cooling the removed product; and (k) packing the cooled product.

In the (a) step of kneading the raw material, the reason for kneading the raw material is to increase viscosity of the material in order to realize the optimal conditions, and in the (b) step, the reason for making the kneaded material into the sheet is to easily charge and cast it in the mold.

The raw material of the synthetic marble in the (a) step consists of 200 to 500 parts by weight of an inorganic filler, 0.2 to 5 parts by weight of a cross linking agent, and 0.2 to 3 parts by weight of cross-linking promoter with respect to 100 parts by weight of acryl-based resin syrup consisting of 10 to 50% by weight of acryl-based resin and 50 to 90% by weight of acryl-based monomer.

It is preferable that a polymerable monomer of the acryl resin syrup used in the present invention is acryl monomer. In detail, the acryl resin syrup is a methacrylate monomer selected from or a compound of at least two selected from methyl methacrylate, ethyl methacrylate, butyl methacrylate, 2-ethylhexyl methacrylate, benzyl methacrylate, and glycidyl methacrylate, or a compound of the methacrylate monomer and a polymer that the methacrylate monomer is partially polymerized, and preferably, methyl methacrylate. It is preferable that the content of the polymer in the syrup is 10 to 50% by weight.

The inorganic filler used in the present invention is one selected from or a compound consisting of two or more materials selected from inorganic powders which are generally used in the field, such as aluminum hydroxide, magnesium hydroxide, calcium aluminate, calcium carbonate, silica powder, alumina, and so on. It is preferable that the particle size of the inorganic filler is 3 μm to 200 μm, and it is preferable to have the surface treated with silane coupling agent, titanate coupling agent, or stearates in consideration of dispersibility of resin, improvement of mechanical strength of the product, and prevention of precipitation. A desirable content of the inorganic filler is 200 to 500 parts by weight with respect to 100 parts by weight of resin syrup. If the content of the inorganic filler is low, pearl is concentrated on one direction due to a difference of specific gravity, but if the content of the inorganic filler is too high, moldability and workability are deteriorated.

The cross linking agent used in the present invention is a multifunctional acryl-based monomer serving polymerable double link in molecules and cross link with the acryl resin syrup, and is one selected from or a compound consisting of two or more materials selected from ethylene glycol dimethacrylate, di (ethylene glycol) dimethacrylate, tetra (ethylene glycol) dimethacrylate, trimethylolpropane trimethacrylate, 1,6-hexanediol dimethacrylate, polybutylene glycol dimethacrylate, and neopentyl glycol dimethacrylate, and preferably, ethylene glycol dimethacrylate.

If the cross linking agents are not used or used too little, the surface is uneven, bubbles are formed at upper and lower parts of the synthetic marble due to a low binding force between the materials, and heat resistance and discoloration resistance are deteriorated. If the cross linking agents are used too much, there occur many problems in patterns of the synthetic marble due to a phase separation of the chips. Therefore, it is preferable that the content of the cross linking agent is 0.2 to 5 parts by weight with respect to 100 parts by weight of resin syrup. If the content of the cross linking agent is less than 0.2 parts by weight, the casting period of time becomes longer to thereby deteriorate productivity, and if the content of the cross linking agent is more than 5 parts by weight, cracks may be formed due to a sharp hardening.

The cross-linking promoter used in the present invention is one selected from or a compound consisting of two or more materials selected from diacyl peroxide such as benzoyl peroxide and dicumyl peroxide, hydro peroxide such as butylhydro peroxide and cumylhydro peroxide, t-butyl peroxy maleic acid, t-butylhydro peroxide, t-butylhydro peroxy butyrate, acetyl peroxide, lauroyl peroxide, azobisisobutyronitrile, azobisdimethylvalero nitrile, t-butyl peroxyneodecanoate, and t-amyl peroxy 2-ethylhexanoate. Moreover, polymerization and hardening may be carried out at room temperature using a mixture of amine peroxide and sulfonic acid or a mixture of peroxide and cobalt compound. It is preferable that the content of the cross-linking promoter is 0.2 to 3 parts by weight with respect to 100 parts by weight of resin syrup, and the cross-linking promoter is used together with polymerization promoter.

Moreover, a radical carrier such as a mercaptan compound of normal dodecyl mercaptan, tert-dodecyl mercaptan, benzyl mercaptan, and trimethyl benzyl mercaptan. It is preferable that the content of the radical carrier is 0.1 to 5 parts by weight with respect to 100 parts by weight of resin syrup.

Color-forming means used in the present invention is not specially restricted, and organic or inorganic paints or pigments which are generally known as ingredients for synthetic marble may be used. Furthermore, for pearl pigments, various pigments such as gold, silver, bronze, aluminum, pearl, and so on may be used.

Besides the above, as generally known additives for synthetic marble, the composite may further include one or more additive selected from: silicon-based or nonsilicon-based antifoaming agent; silane-based, acid-based or titanate-based coupling agent whose main ingredient is trimethoxysilane; phenyl salicylate-based, benzophenone-based, benzotriazole-based, nickel derivative-based, radical scavenger-based ultraviolet ray absorbent; halogen-based, phosphorus-based, or inorganic metal-based flame retardant; stearine-based or silicon-based releasing agent; catechol-based or hydroquinones-based polymerization inhibitor; and phenon-based, amine-based, quinone-based, sulfur-based, or phosphorus-based antioxidant.

In the casting step, casting pressure is 5 to 50 kg/cm² and casting temperature is 30 to 150° C. If the casting pressure is less than 5 kg/cm², the compound is not casted, and if the casting pressure is more than 50 kg/cm², an excessive bun occurs.

The pencil hardness of the synthetic marble manufactured through the above manufacturing method is more than 7H, preferably, within a range of 7H to 8H.

While the present invention has been particularly shown and described with reference to exemplary embodiments thereof, it will be understood by those of ordinary skill in the art that various changes in form and details may be made therein without departing from the spirit and scope of the present invention as defined by the following claims.

### Embodiment

1. Manufacturing of Sheet

A resin pigment composite of a single color was manufactured by mixing 0.3 parts by weight of pigment to raw material slurry consisting of: 100 parts by weight of methylmethacrylate syrup including a compound consisting of 30% by weight of polymethyl methacrylate and 70% by weight of methyl methacrylate; 400 parts by weight of aluminum hydroxide; 0.2 parts by weight of t-butyl peroxyneodecanoate; 0.3 parts by weight of t-amyl peroxy 2-ethylhexanoate; 3 parts by weight of ethylene glycol dimethacrylate; 0.2 parts by weight of normal dodecyl mercaptan; 0.2 parts by weight of antifoamer, BYK 555 (BYK-Chemie Company, Germany), 0.75 parts by weight of coupling agent, BYK 900 (BYK-Chemie Company, Germany); and 0.2 parts by weight of ultraviolet ray absorbent, Hisorp-P (LG Chemicals).

2. Manufacturing of Synthetic Marble

The compound manufactured into a sheet state was coated to a thickness of about 1 mm using a roll coater. In this instance, the content of the materials for coating was 100 parts by weight of unsaturated polyester resin, 1.0 parts by weight of t-butylhydro peroxy butyrate, 100 parts by weight of silica as the filler, 10 parts by weight of zinc stearates as the releasing agent, and the materials were mixed together and coated. The coated sheet was charged in a mold preheated at temperature of 120° C. and casted at pressure of 15 kg/cm². After a removal of the form, the casted product was cooled to thereby obtain the synthetic marble with high hardness.

3. Evaluation

As described above, the raw material consisting of silica with solid surface of high hardness was coated and casted to thereby obtain the pencil hardness of 7H to 8H, so that the synthetic marble according to the present invention could secure scratch resistance and high hardness better than the existing casted products with hardness of 5H.

1. A synthetic marble having a surface layer whose raw material is a compound with a pencil hardness of 7 to 9.

2. The synthetic marble according to claim 1, wherein the compound with the pencil hardness of 7 to 9 is at least one selected from a group consisting of silica and silicon carbide.

3. The synthetic marble according to claim 1, wherein the content of the compound with the pencil hardness of 7 to 9 is 50 to 300 parts by weight with respect to 100 parts by weight of resin.

4. The synthetic marble according to claim 2, wherein the particle size of silica is 1 μm to 30 μm.

5. A method of manufacturing the synthetic marble comprising the steps of:
(a) kneading the raw material of the synthetic marble;
(b) making the kneaded material into a sheet;
(c) putting and mulling sheets of at least two kinds in a kneader;
(d) putting and mulling pearl pigments;
(e) making the mulled material into a sheet;
(f) coating a compound with a pencil hardness of 7 to 9 to the sheet; and
(g) charging and casting the coated compound in a mold and removing the form and cooling the formed product.

6. The method of manufacturing the synthetic marble according to claim 5, wherein the compound with the pencil hardness of 7 to 9 is at least one selected from a group consisting of silica and silicon carbide.

7. The method of manufacturing the synthetic marble according to claim 5, wherein in the (a) step, the raw material of the synthetic marble consists of 200 to 500 parts by weight of an inorganic filler, 0.2 to 5 parts by weight of a cross linking agent, and 0.2 to 3 parts by weight of cross-linking promoter with respect to 100 parts by weight of acryl-based resin syrup consisting of 10 to 50% by weight of acryl-based resin and 50 to 90% by weight of acryl-based monomer.

8. The method of manufacturing the synthetic marble according to claim 5, wherein the acryl-based monomer is a methacrylate monomer selected from or a compound consisting of two or more materials selected from methyl methacrylate, ethyl methacrylate, butyl methacrylate, 2-ethylhexyl methacrylate, benzyl methacrylate, and glycidyl methacrylate, and the acryl-based resin is one or more polymers of the acryl-based monomers.

9. The method of manufacturing the synthetic marble according to claim 5, wherein the inorganic filler is at least one selected from aluminum oxide, magnesium hydroxide, calcium aluminate, calcium carbonate, silica powder, and alumina.

10. The method of manufacturing the synthetic marble according to claim 5, wherein the cross linking agent is one selected from or a compound consisting of two or more materials selected from ethylene glycol dimethacrylate, di (ethylene glycol) dimethacrylate, tetra (ethylene glycol) dimethacrylate, trimethylolpropane trimethacrylate, 1,6-hexanediol dimethacrylate, polybutylene glycol dimethacrylate, and neopentyl glycol dimethacrylate.

11. The method of manufacturing the synthetic marble according to claim 5, wherein the cross-linking promoter is one selected from or a compound consisting of two or more materials selected from benzoyl peroxide, dicumyl peroxide, butylhydro peroxide, cumylhydro peroxide, t-butyl peroxy maleic acid, t-butylhydro peroxide, t-butylhydro peroxy butyrate, acetyl peroxide, lauroyl peroxide, azobisisobutyronitrile, azobisdimethylvalero nitrile, t-butyl peroxyneodecanoate, and t-amyl peroxy 2-ethylhexanoate.

12. The method of manufacturing the synthetic marble according to claim 5, wherein in the (g) step, casting pressure is 5 to 50 kg/cm² and casting temperature is 30 to 150° C.
